(19) United States
(12) Patent Application Publication
(10) Pub. No.: US 2009/0002767 A1
(43) Pub. Date: Jan. 1, 2009

(54) Picture Color Tone Controlling Apparatus and Picture Color Tone Controlling Method for a Printing Press

(75) Inventors: Ikuo Ozaki, Hiroshima (JP); Shuichi Takemoto, Mihara (JP); Norifumi Tasaka, Mihara (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD., Tokyo (JP)

(21) Appl. No.: 12/160,881

(22) PCT Filed: Jan. 22, 2007
(86) PCT No.: PCT/JP2007/050921

§ 371 Date: Aug. 21, 2008

(30) Foreign Application Priority Data
Jan. 20, 2006 (JP) 2006-012447

(51) Int. Cl. G06K 15/00

(52) U.S. Cl. 358/3.06

(57) ABSTRACT

The object of the present invention is to provide a picture color tone controlling apparatus and a picture color tone controlling method for a printing press wherein, also where different kinds of screening are used jointly to carry out printing, color tone control can be carried out with high accuracy. The picture color tone controlling apparatus for a printing press includes a printing characteristic information acquisition section for acquiring printing characteristic information of a printing press corresponding to different kinds of screening used for plate making of a printing picture, a screening information acquisition section 18B for acquiring the kinds of screening to be used for different regions of the printing picture in an associated relationship with the regions, a noticed pixel region setting section 18A for setting a specific pixel region in the printing picture as a noticed pixel region for each of ink supplying zones of the printing press, and an ink supplying amount controlling section 20 for controlling a supplying amount of ink based on the printing characteristic information corresponding to the kinds of screening of the noticed pixel region.

### TECHNICAL FIELD

The present invention relates to a picture color tone controlling apparatus and a picture color tone controlling method for a printing press wherein information regarding a printing characteristic of a printing press is used to control the color tone of a picture.

### BACKGROUND ART

Various proposals have been made as a technique for controlling the color tone of a picture of a printing press.

For example, in Patent Document 1, a technique is proposed wherein the color tone of a print is adjusted during printing operation.

First, a target color mixture halftone density is set for each ink supplying width. The color mixture halftone density indicates a reflection density of each color of I (infrared light), R (red), G (green), and B (blue). Then, an actual tone value of each ink color corresponding to an actual color mixture halftone density is determined based on a corresponding relationship (an LUT (look-up table) according to the corresponding relationship or a publicly known Neugebauer's expression derived from the corresponding relationship) between tone values and color mixture halftone densities of each of ink colors of black (k), cyan (c), magenta (m), and yellow (y) set in advance.

As a method of determining a corresponding relationship LUT, for example, a print (picture having various combinations of the four ink colors [black (k), cyan (c), magenta (m), and yellow (y)] which are basic colors) according to the standards of the Japan Color (ISO12642) for Newspaper Printing established by the ISO/TC130 National Commission is printed first with a reference density Ds and actual measurement is carried out using an IRGB densitometer so that a corresponding relationship of actual measurement values (values of the color mixture halftone density IRGB) by the IRGB densitometer to various combinations of the tone values of the four ink colors k, c, m and y is determined, and a look-up table (LUT) can be determined from the corresponding relationship. Further, as a different method for determining a corresponding relationship LUT, also it is possible to utilize a database of actual measurement values by an IRGB densitometer corresponding to combinations of tone values of k, c, m and y to utilize a value approximated with the publicly known Neugebauer's expression.

Further, a target tone value of each ink color corresponding to the target color mixture halftone density is also determined based on the corresponding relationship LUT described above. Different from the actual tone value, the target tone value need not be calculated every time, but it is necessary to calculate the target tone value once as long as the target color mixture halftone density does not change. For example, the target tone value may be calculated at a point of time at which the target color mixture halftone density is set.

Then, an actual monochromatic halftone density corresponding to the actual tone value is determined based on a corresponding relationship between tone values and monochromatic halftone densities set in advance. As a method for determining an actual monochromatic halftone density from the actual tone value, the actual monochromatic halftone density may be determined by approximating the relationship using a map or a table of actual monochromatic halftone densities corresponding to actual tone values or the publicly known Yule-Nielsen's expression and utilizing the approximated relationship. Further, a target monochromatic halftone density corresponding to the target tone value is also calculated based on the corresponding relationship between tone values and monochromatic halftone densities. Different from the actual monochromatic halftone density, the target monochromatic halftone density need not be determined every time, but it is necessary to calculate the target monochromatic halftone density once as long as the target tone value does not change. For example, the target monochromatic half tone density may be determined at a point of time at which the target tone value is set.

Next, a solid density difference corresponding to the difference between the target monochromatic halftone density and the actual monochromatic halftone density under the target tone value is determined based on a corresponding relationship among tone values, monochromatic halftone densities and solid densities set in advance.

As a method for calculating the solid density difference, a map or a table indicating a corresponding relationship among tone values, monochromatic halftone densities and solid densities may be prepared such that the target tone value, target monochromatic halftone density and actual monochromatic halftone density are allocated to the map or the table, or the relationship described above may be approximated using the publicly known Yule-Nielsen's expression such that the solid density difference is calculated utilizing the approximated relationship. Then, the ink supplying amount is adjusted for each ink supplying width based on the calculated solid density difference and the supplying amount for each ink color is controlled for each ink supplying width. The adjustment amount for the ink supplying amount based on the solid density difference can be determined using an API function described above.

Further, as a setting method for a target color mixture halftone density in a case wherein kcmy tone value data (for example, image data for plate making or the like) of a printing object picture can be acquired, the following point has been proposed.

First, for the acquired image data (kcmy tone value data), a noticed pixel (which may be one pixel or a group of successively provided pixels) corresponding to each ink color is set for each ink supplying width among pixels which form a printing object picture, and a tone value of the noticed pixel is converted into a color mixture halftone density based on the corresponding relationship between tone values and color mixture halftone densities set in advance. Then, the color mixture halftone density of the noticed pixel is set as the target color mixture halftone density, and an actual color mixture halftone density of the set noticed pixel is measured.

Consequently, since color development can be estimated in a unit of a pixel by utilizing the database of the Japan Color or the like, color tone control can be carried out for a particular noticed point (noticed pixel) of a picture at a point of time immediately after printing starts without waiting for an OK sheet to be printed.

In this manner, a pixel whose autocorrelation is highest with respect to the tone value of each pixel is calculated and extracted for each ink color and the extracted pixel is set as a noticed pixel, and then a target monochromatic halftone density and an actual monochromatic halftone density are calculated regarding the noticed pixel to carry out feedback control of the ink supplying amount so that the actual monochromatic halftone density may approach the target monochromatic halftone density. As a result, color tone control stabilized further can be carried out.

### Patent Document 1: Japanese Patent Laid-Open No. 2004-106523

### DISCLOSURE OF THE INVENTION

### Subject to Be Solved by the Invention

Incidentally, screening is necessary in order to carry out plate making of a printing picture. Although, as a screening method, AM screening (Amplitude Modulation Screening) is used most popularly, in recent years, FM screening (Frequency Modulation Screening) is also used in order to carry out high-definition printing. Also there is a case wherein the AM screening and the FM screening are used jointly in the same print in accordance with a characteristic of a printing picture.

For example, in newspaper printing or the like, there is a case wherein plate making is carried out using different kinds of screening for different pages. Usually, in newspaper printing, since a plurality of pages are allocated to a printing plate, where a different kind of screening is used for each page, a plurality of kinds of screening are used. It is to be noted that different kinds of screening may be used jointly in the same page.

However, there is a case wherein, where a plurality of kinds of screenings are used for the same printing plate, even if color tone control of a print is carried out using the technique of Patent Document 1, the desired color tone is not obtained on the print. Further, a dispersion appears in the color tone of prints for each kind of screening, and for example, where a different kind of screening is used each page, the quality is deteriorated in that the color tone of the print differs among different pages.

When the cause of the degradation of the quality was investigated, it was confirmed that this arises from the fact that the degree of the dot gain is much different between the AM screening and the FM screening. In particular, while, in the AM screening, shading is represented by the size of the area of one halftone dot whose area is comparatively great, in the FM screening, a great number of halftone dots of a very small area are disposed such that the distribution density of the halftone dots is varied to represent the shading.

Therefore, in the same tone value per a unit area, the area of a halftone dot in the FM screening is smaller than that in the AM screening (the number of halftone dots per unit area in the FM screening is greater than that in the AM screening). The characteristic of dot gains differs depending upon the difference in area of the halftone dots. It is to be noted that this phenomenon appears also in a case wherein different AM screenings which are different in the number of lines (number of halftone dots per unit area) are used jointly.

In this manner, since, if the characteristic of dot gains is different among different kinds of screening, then a dispersion appears in the optical (apparent) halftone dot area of each color actually transferred to a print, the color tone of the print varies. Therefore, with the conventional method, it has been difficult to carry out color tone control with high accuracy where a plurality of kinds of screening are used for one printing plate.

The present invention has been made in view of such subjects as described above, and it is an object of the present invention to provide a picture color tone controlling apparatus and a picture color tone controlling method for a printing press wherein color tone control can be carried out with high accuracy even in a case wherein different kinds of screening are used jointly to carry out printing.

### SUMMARY OF THE INVENTION

In order to attain the object described above, according to an aspect of the present invention, there is provided a picture color tone controlling apparatus (claim 1) for a printing press, comprising a printing characteristic information acquisition section for acquiring printing characteristic information of a printing press corresponding to different kinds of screening used for plate making of a printing picture, a screening information acquisition section for acquiring the kinds of screening to be used for different regions of the printing picture in an associated relationship with the regions, and an ink supplying amount controlling section for controlling a supplying amount of ink based on the printing characteristic information corresponding to the kinds of screening of the noticed pixel region.

Preferably, the picture color tone controlling apparatus for a printing press further comprises a noticed pixel region setting section for setting a specific pixel region in the printing picture as a noticed pixel region for each of ink supplying zones of the printing press, and the ink supplying amount controlling section controlling the ink supplying amount based on the printing characteristic information corresponding to the kind of screening of each noticed pixel region set by the noticed pixel region setting section (claim 2).

Preferably, the printing characteristic information is a look-up table for each of the kinds of screening each of which defines a corresponding relationship between tone values k, c, m, y of each ink color and color mixture halftone densities I, R, G, B obtained by printing a predetermined picture with a reference solid density for each of the kinds of screening and actually measuring a color mixture halftone density of the printed matter using an IRGB densitometer, and the ink supplying amount controlling section controls the ink supplying amount using the look-up table corresponding to the kind of screening of the noticed pixel region (claim 3).

Preferably, the ink supplying amount controlling section includes an ink supplying section for supplying ink for each of regions divided in a printing widthwise direction, a target color mixture halftone density setting section for setting a target color mixture halftone density for each ink supplying width when the printing picture is divided by the ink supplying width of the ink supplying section, an actual color mixture halftone density acquisition section for acquiring a color mixture halftone density of an actually printed sheet obtained by printing using the IRGB densitometer disposed on a traveling line of the actually printed sheet, a target tone value calculation section for calculating a target tone value of each ink color corresponding to the target color mixture halftone density based on the look-up table corresponding to the kind of screening of the noticed pixel region, an actual tone value calculation section for calculating an actual tone value of each ink color corresponding to the actual color mixture halftone density based on the look-up table corresponding to the kind of screening of the noticed pixel region, a target monochromatic halftone density calculation section for calculating a target monochromatic halftone density corresponding to the target tone value based on a corresponding relationship in advance between tone values and monochromatic halftone densities set, an actual monochromatic halftone density calculation section for calculating an actual monochromatic halftone density corresponding to the actual tone value based on the corresponding relationship between the tone values and the monochromatic halftone densities, and a solid density difference calculation section for calculating a solid density difference corresponding to a difference between the target monochromatic halftone density and the actual monochromatic halftone density under the target tone value based on a corresponding relationship set in advance among the tone values, monochromatic halftone densities and solid densities, the ink supplying amount controlling section controlling the ink supplying amount for each ink supplying width by feedback control based on the solid density difference (claim 4).

In this case, preferably the target color mixture halftone density setting section includes a tone value data acquisition section for acquiring kcmy tone value data of the printing picture and a conversion section for converting the tone value of the noticed pixel region obtained from the tone value data into a color mixture halftone density using the look-up table corresponding to the kind of screening of the noticed pixel region, and is configured so as to set the color mixture halftone density of the noticed pixel region as the target color mixture halftone density, the actual color mixture halftone density acquisition section being configured so as to acquire the actual color mixture halftone density of the noticed pixel (claim 5).

Preferably, the printing characteristic information includes a reference look-up table which defines a corresponding relationship between tone values k, c, m, y of each ink color and color mixture halftone densities I, R, G, B obtained by printing a predetermined picture of a printing plate made in accordance with the screening which is a reference with a reference solid density and measuring a color mixture halftone density of the printed matter using an IRGB densitometer and dot gain characteristic information corresponding to the kind of screening, the ink supplying amount controlling section controlling the ink supplying amount based on the reference look-up table and a difference between the dot gain characteristic information corresponding to the kind of screening of the noticed pixel region and the dot gain characteristic information corresponding to the kind of screening which is a reference screening (claim 6).

In this case, preferably the ink supplying amount controlling section includes an ink supplying section for supplying ink for each of regions divided in a printing widthwise direction, a target color mixture halftone density setting section for setting a target color mixture halftone density for each ink supplying width when the printing picture is divided by the ink supplying width of the ink supplying section, an actual color mixture halftone density acquisition section for acquiring a color mixture halftone density of an actually printed sheet obtained by printing using an IRGB densitometer disposed on a traveling line of the actually printed sheet, a target tone value calculation section for calculating a target tone value of each ink color corresponding to the target color mixture halftone density based on the reference look-up table, an actual tone value calculation section for calculating an actual tone value of each ink color corresponding to the actual color mixture halftone density based on the reference look-up table, a target monochromatic halftone density calculation section for calculating a target monochromatic halftone density corresponding to the target tone value based on a corresponding relationship set in advance between tone values and monochromatic halftone densities, an actual monochromatic halftone density calculation section for calculating an actual monochromatic halftone density corresponding to the actual tone value based on the corresponding relationship between the tone values and the monochromatic halftone densities, and a solid density difference calculation section for calculating a solid density difference corresponding to a difference between the target monochromatic halftone density and the actual monochromatic halftone density under the target tone value based on a corresponding relationship set in advance among the tone values, monochromatic halftone densities and solid densities, the ink supplying amount controlling section controlling the ink supplying amount for each ink supplying width by feedback control based on the solid density difference (claim 7).

Further preferably, the target color mixture halftone density setting section includes a tone value data acquisition section for acquiring kcmy tone value data of the printing picture, a post-correction tone value calculation section for calculating a post-correction tone value to be obtained by correcting the tone value of the noticed pixel region obtained from the tone value data based on a difference between the dot gain characteristic information corresponding to the kind of screening of the noticed pixel region and the dot gain characteristic information corresponding to the kind of screening which is a reference and a conversion section for converting the post-correction tone value into the color mixture halftone density using the reference look-up table, and is configured so as to set the converted color mixture halftone density of the noticed pixel region as the target color mixture halftone density, the actual color mixture halftone density acquisition section being configured so as to acquire the actual color mixture halftone density of the noticed pixel (claim 8).

Preferably, the screening information acquisition section acquires the screening information from job ticket data (claim 9).

Preferably, the screening information acquisition section acquires the screening information from plate making data (claim 10).

Preferably, the printing characteristic information acquisition section acquires the printing characteristic information from job ticket data (claim 11).

According to another aspect of the invention, there is provided a picture color tone controlling method (claim 12) for a printing press, comprising a printing characteristic information acquisition step of acquiring printing characteristic information of a printing press corresponding to different kinds of screening used for plate making of a printing picture, a screening information acquisition step of acquiring the kinds of screening to be used for different regions of the printing picture in an associated relationship with the regions, and an ink supplying amount controlling step of controlling a supplying amount of ink based on the printing characteristic information corresponding to the kinds of screening.

Preferably, the picture color tone controlling method for a printing press further comprises a noticed pixel region setting step of setting a specific pixel region in the printing picture as a noticed pixel region for each of ink supplying zones of the printing press, and wherein, at the ink supplying amount controlling step, the ink supplying amount is controlled based on the printing characteristic information corresponding to the kind of screening of each noticed pixel region (claim 13).

Also in this case, preferably the printing characteristic information is a look-up table for each of the kinds of screening each of which defines a corresponding relationship between tone values k, c, m, y of each ink color and color mixture halftone densities I, R, G, B obtained by printing a predetermined picture with a reference solid density for each of the kinds of screening and actually measuring a color mixture halftone density of the printed matter using an IRGB densitometer, and, at the ink supplying amount controlling step, the ink supplying amount is controlled using the look-up table corresponding to the kind of screening of the noticed pixel region (claim 14).

Further preferably, the ink supplying amount controlling step includes a target color mixture halftone density setting step of setting a target color mixture halftone density for each ink supplying width when the printing picture is divided by the ink supplying width of the ink supplying section, an actual color mixture halftone density acquisition step of acquiring a color mixture halftone density of an actually printed sheet obtained by printing using the IRGB densitometer disposed on a traveling line of the actually printed sheet, a target tone value calculation step of calculating a target tone value for each ink color corresponding to the target color mixture halftone density based on the look-up table corresponding to the kind of screening of the noticed pixel region, an actual tone value calculation step of calculating an actual tone value for each ink color corresponding to the actual color mixture halftone density based on the look-up table corresponding to the kind of screening of the noticed pixel region, a target monochromatic halftone density calculation step of calculating a target monochromatic halftone density corresponding to the target tone value based on a corresponding relationship set in advance between tone values and monochromatic halftone densities, an actual monochromatic halftone density calculation step of calculating an actual monochromatic halftone density corresponding to the actual tone value based on the corresponding relationship between the tone value and the monochromatic halftone density, and a solid density difference calculation step of calculating a solid density difference corresponding to a difference between the target monochromatic halftone density and the actual monochromatic halftone density under the target tone value based on a corresponding relationship set in advance among the tone values, monochromatic halftone densities and a solid densities, the ink supplying amount being controlled for each ink supplying width by feedback control based on the solid density difference (claim 15).

Further preferably, the target color mixture halftone density setting step includes a tone value data acquisition step of acquiring kcmy tone value data of the printing picture and a conversion step of converting the tone value of the noticed pixel region obtained from the tone value data into a color mixture halftone density using the look-up table corresponding to the kind of screening of the noticed pixel region, and is configured so as to set the color mixture halftone density of the noticed pixel region as the target color mixture halftone density, the actual color mixture halftone density acquisition step being configured so as to acquire the actual color mixture halftone density of the noticed pixel (claim 16).

Preferably, the printing characteristic information includes a reference look-up table which defines a corresponding relationship between tone values k, c, m, y of each ink color and color mixture halftone densities I, R, G, B obtained by printing a predetermined picture of a printing plate made in accordance with the screening which is a reference with a reference solid density and measuring a color mixture halftone density of the printed matter using an IRGB densitometer and dot gain characteristic information corresponding to the kind of screening, the ink supplying amount being controlled at the ink supplying amount controlling step based on the reference look-up table and a difference between the dot gain characteristic information corresponding to the kind of screening of the noticed pixel region and the dot gain characteristic information corresponding to the kind of screening which is a reference (claim 17).

In this case, preferably the ink supplying amount controlling step includes a target color mixture halftone density setting step of setting a target color mixture halftone density for each ink supplying width when the printing picture is divided by the ink supplying width of the ink supplying section, an actual color mixture halftone density acquisition step of acquiring a color mixture halftone density of an actually printed sheet obtained by printing using the IRGB densitometer disposed on a traveling line of the actually printed sheet, a target tone value calculation step of calculating a target tone value of each ink color corresponding to the target color mixture halftone density based on the reference look-up table, an actual tone value calculation step of calculating an actual tone value of each ink color corresponding to the actual color mixture halftone density based on the reference look-up table, a target monochromatic halftone density calculation step of calculating a target monochromatic half tone density corresponding to the target tone value based on a corresponding relationship set in advance between tone values and monochromatic halftone densities, an actual monochromatic halftone density calculation step of calculating an actual monochromatic halftone density corresponding to the actual tone value based on the corresponding relationship between the tone values and the monochromatic halftone densities, and a solid density difference calculation step of calculating a solid density difference corresponding to a difference between the target monochromatic halftone density and the actual monochromatic halftone density under the target tone value based on a corresponding relationship set in advance among the tone values, monochromatic halftone densities and solid densities, the ink supplying amount being controlled for each ink supplying width by feedback control based on the solid density difference (claim 18).

Further preferably, the target color mixture halftone density setting step includes a tone value data acquisition step of acquiring kcmy tone value data of the printing picture, a post-correction tone value calculation step of calculating a post-correction tone value to be obtained by correcting the tone value of the noticed pixel region obtained from the tone value data based on a difference between the dot gain characteristic information corresponding to the kind of screening of the noticed pixel region and the dot gain characteristic information corresponding to the kind of screening which is a reference and a conversion step of converting the post-correction tone value into the color mixture halftone density using the reference look-up table, and is configured so as to set the converted color mixture halftone density of the noticed pixel region as the target color mixture halftone density, the actual color mixture halftone density acquisition step being configured so as to acquire the actual color mixture halftone density of the noticed pixel (claim 19).

Preferably, at the screening information acquisition step, the screening information is acquired from job ticket data (claim 20).

Preferably, at the screening information acquisition step, the screening information is acquired from plate making data (claim 21).

Preferably, at the printing characteristic information acquisition step, the printing characteristic information is acquired from job ticket data (claim 22).

### EFFECTS OF THE INVENTION

With the picture color tone controlling apparatus (claim 1) for a printing press and the picture color tone controlling method (claim 12) for a printing press of the present invention, since, even if a plurality of kinds of screening different from each other are used for the same printing plate, the ink supplying amount can be controlled based on the printing characteristic of each kind of screening, the dispersion of the color tone between different kinds of screening can be reduced and picture color tone control for a printing press can be carried out with high accuracy.

Particularly, since a particular pixel region (for example, a region in which it is desired to carry out color tone control particularly with high accuracy) in the printing picture is set as a noticed pixel region for each of ink supplying zones of the printing press and the ink supplying amount is controlled based on the printing characteristic information corresponding to the kind of screening of each noticed pixel region, picture color tone control for a printing press can be carried out with high accuracy for the necessary specific pixel region (claims 2, 13).

Further, the ink supplying amounts for the ink colors k, c, m and y are controlled using a look-up table which defines a corresponding relationship between tone values k, c, m and y and color mixture halftone densities I, R, G and B for each ink color for each kind of screening. Therefore, picture color tone control for a printing press can be carried out with high accuracy (claims 3, 14).

In this instance, feedback control of the ink supplying amount of each ink color k, c, m and y is carried out based on an actual color mixture halftone density of an actual printed sheet detected by the IRGB densitometer and a target color mixture halftone density. Therefore, picture color tone control for a printing press can be carried out with high accuracy and certainty (claims 4, 15).

Further, a target color mixture halftone density is set from a tone value of a printing picture using a look-up table corresponding to a kind of screening to be used for ink supplying amount control. Therefore, accurate color tone control corresponding to a kind of screening of a noticed pixel region can be carried out at a point of time immediately after starting of printing without waiting for an OK sheet to be printed, and the time until the OK sheet is obtained after starting of printing can be reduced further to reduce paper loss (claims 5, 16).

Further, the ink supplying amounts of the ink colors k, c, m and y are controlled based on the difference between the dot gain characteristic of each kind of screening and the dot gain characteristic in kind of screening which is the reference. Therefore, picture color tone control for a printing press can be carried out with high accuracy (claims 6, 17).

Further, feedback control of the ink supplying amounts of the ink colors k, c, m and y is carried out based on the actual color mixture halftone density of the actual printing sheet detected by the IRGB densitometer and the target color mixture half tone density. Therefore, picture color tone control for a printing press can be carried out with high accuracy and certainty (claims 7, 18).

Further, the target color mixture halftone density is set using the reference look-up table from a post-correction tone value corrected in response to a difference between the dot gain characteristic information corresponding to the kind of screening of the noticed pixel region and the dot gain characteristic information corresponding to the kind of screening which is the reference. Therefore, the magnitude difference of the dot gain arising from the difference of the kind of screening regarding the noticed pixel region can be corrected at a point of time immediately after starting of printing without waiting for an OK sheet to be printed to carry out color tone control accurately, and the time can be saved between the beginning of printing and the obtainment of an OK sheet, resulting in reduced paper loss (claims 8, 19).

Further, a person in charge of space configuration such as, for example, a designer of a paper space to be printed or the like writes, upon production of plate making data and printing job ticket data, information regarding a kind of screening to be used for picture color tone control into job ticket data and uses the written information regarding a kind of screening upon printing. Therefore, picture color tone control can be carried out with high accuracy such that the print has a desired color tone (claims 9, 20).

Further, since screening information can be acquired from the plate making data, picture color tone control can be carried out with high accuracy such that the print has a desired color tone (claims 10, 21).

Further, for example, printing characteristic information acquired for each kind of screening in advance by a base station or the like is written into job ticket data, and in a printing factory, the printing characteristic information is acquired from the job ticket data. Therefore, printing characteristic information need not be acquired by the printing factory, and the working load to be applied to printing can be reduced (claims 11, 22).

### BRIEF DESCRIPTION OF THE DRAWINGS

FIG. 1 is a view showing a general configuration of an offset rotary press for newspaper according to a first embodiment of the present invention.

FIG. 2 is a functional block diagram showing a calculation apparatus in FIG. 1 paying attention to a color tone controlling function.

FIG. 3 is a flow chart illustrating a processing flow of color tone control (particularly, a process relating to calculation of a target color mixture halftone density) by the calculation apparatus according to the first embodiment of the present invention.

FIG. 4 is a flow chart illustrating a processing flow of color tone control by the calculation apparatus according to the first embodiment of the present invention.

FIG. 5 is a map for associating monochromatic halftone densities and tone values with each other.

FIG. 6 is a map for associating solid densities with tone values and monochromatic halftone densities.

FIG. 7 is a functional block diagram showing a calculation apparatus according to a second embodiment of the present invention paying attention to a color tone controlling function.

FIG. 8 is a view illustrating a dot gain curve and is a graph for associating the tone value and the halftone dot area increase amount by a dot gain with each other.

FIG. 9 is a flow chart illustrating a processing flow of color tone control (particularly, a process relating to calculation of a target color mixture halftone density) by the calculation apparatus according to the second embodiment of the present invention.

1 line sensor type IRGB densitometer
2a, 2b, 2c, 2d printing unit
3 blanket cylinder
4 printing cylinder
5 ink rollers
6 ink source roller
7 ink key
8 printing sheet
10 calculation apparatus
11 DSP
12 PC
14 color conversion section
15 ink supplying amount calculation section
16 online controlling section
17 key opening limiter calculation section
18 noticed pixel region setting section
20 controlling apparatus
40 printing area monitor
41 reception server

### BEST MODE FOR CARRYING OUT THE INVENTION

### First Embodiment

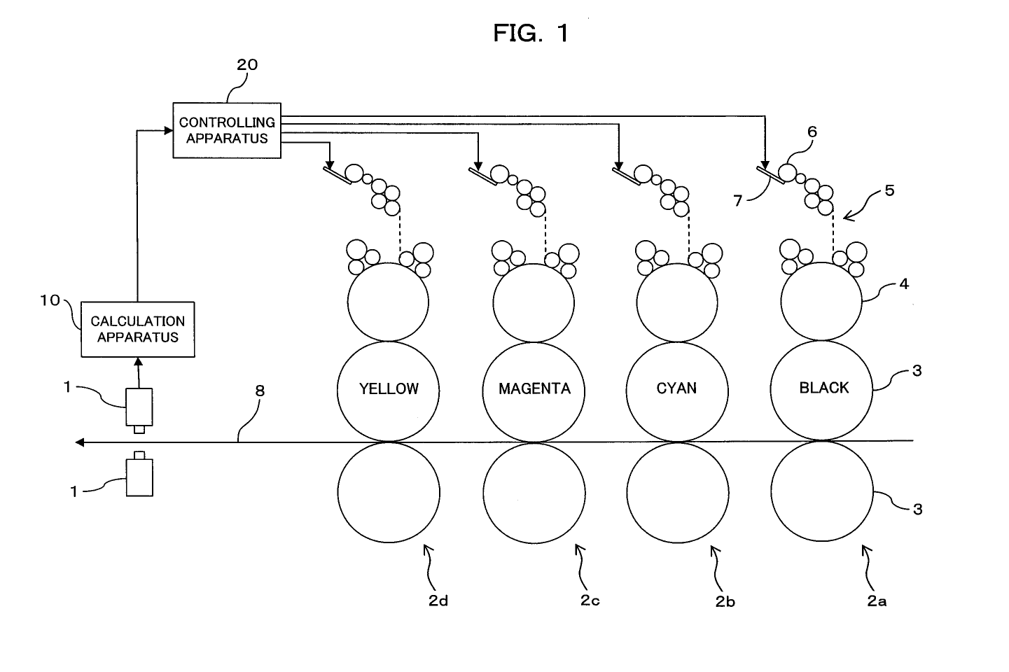

FIG. 1 is a view showing a general configuration of an offset rotary press for newspaper according to a first embodiment of the present invention. As shown in FIG. 1, the newspaper offset rotary press of the present embodiment is a multi-color printing double-sided press and includes printing units 2a, 2b, 2c and 2d provided for different ink colors [black (k), cyan (c), magenta (m), yellow (y)] along a transport path of a printing sheet 8. In the present embodiment, the printing units 2a, 2b, 2c and 2d individually include an ink key type ink supplying apparatus (ink supplying means) formed from an ink key 7 and an ink source roller 6. In the ink supplying apparatus of the type just described, the ink supplying amount can be adjusted in response to a gap amount (the gap amount is hereinafter referred to as ink key opening) of the ink key 7 from the ink source roller 6. It is to be noted that a digital pump apparatus may be used as the ink supplying apparatus.

A plurality of ink keys 7 are provided in parallel to each other in a printing widthwise direction, and the ink supplying amount can be adjusted in response to a width unit (the ink supplying width by the ink key 7 is hereinafter referred to as key zone) of the ink key 7. Ink whose supplying amount is adjusted by the ink key 7 is kneaded suitably within an ink roller group 5 and is supplied to a printing surface of a printing cylinder 4 after a thin film is formed so that the ink adhering to the printing surface is transferred as a picture to the printing sheet 8 through a blanket cylinder 3. It is to be noted that, though not shown in FIG. 1, since the newspaper offset rotary press of the present embodiment can carry out double-sided printing, the printing units 2a, 2b, 2c and 2d individually include a pair of blanket cylinders 3, 3 provided so as to sandwich the transport path of the printing sheet 8, and the printing cylinder 4 and the ink supplying apparatus are provided for each blanket cylinder 3.

The newspaper offset rotary press of the present embodiment includes a line sensor type IRGB densitometer 1 provided on the downstream side with respect to the printing unit 2d on the most downstream side. The line sensor type IRGB densitometer 1 is an instrument for measuring the color of a picture on the printing sheet 8 as a reflection density (color mixture halftone density) of I (infrared light), R (red), G (green) and B (blue) on a line in a printing widthwise direction, and can measure the reflection density of the entire printing sheet 8 or measure the reflection density at an arbitrary position. Since the newspaper offset rotary press of the present embodiment can carry out double-sided printing, the line sensor type IRGB densitometer 1 is disposed on both of front and rear face sides so as to sandwich the transport path of the printing sheet 8 such that reflection densities on both of front and rear faces can be measured.

The reflection density measured by such line sensor type IRGB densitometer 1 is transmitted to a calculation apparatus (computer) 10. The calculation apparatus 10 is an apparatus for calculating controlling data for the ink supplying amount, and carries out calculation based on the reflection density measured by the line sensor type IRGB densitometer 1 so that an opening of the ink key 7 for causing the color of a picture on the printing sheet 8 to coincide with a target color is calculated.

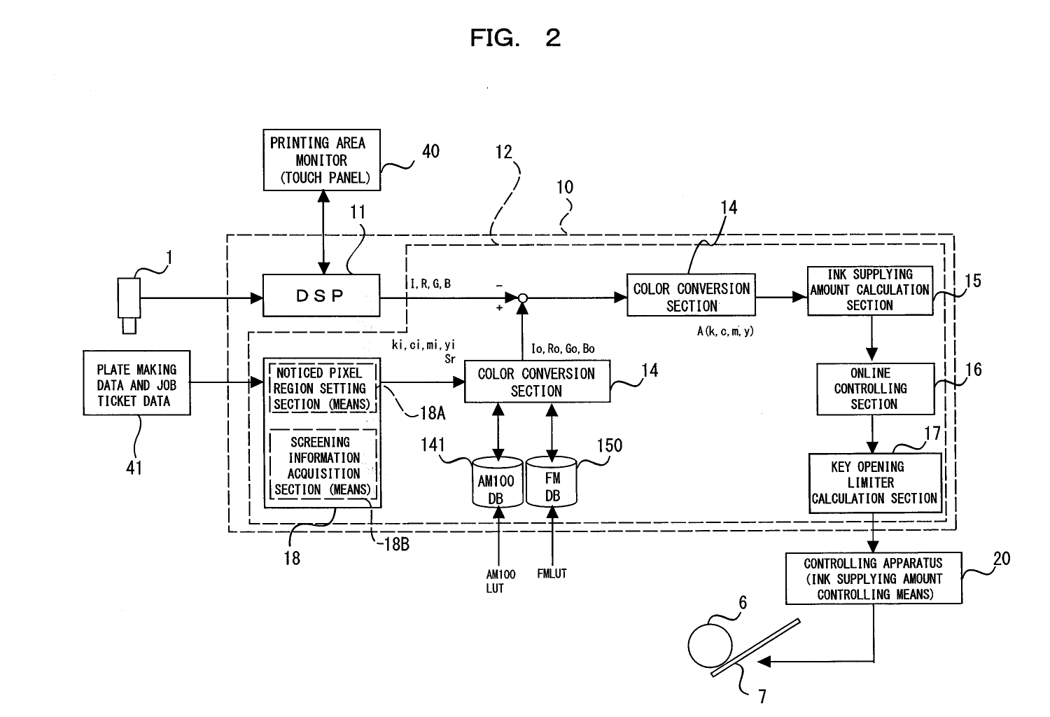

Here, FIG. 2 is a view showing a general configuration of a picture color tone controlling apparatus of the newspaper offset rotary press as the printing press according to the first embodiment of the present invention, and is a functional block diagram showing the calculation apparatus 10 paying attention to a color tone controlling function.

The calculation apparatus 10 is composed of a DSP (digital signal processor) 11 and a PC (personal computer) 12 which are located in a spaced relationship from the printing press, and functions as color conversion sections 14, an ink supplying amount calculation section 15, an online controlling section 16, a key opening limiter calculation section 17 and an information processing section 18 are allocated to the PC 12.

The line sensor type IRGB densitometer 1 and a controlling apparatus 20 built in the printing press are connected to the input side and the output side of the calculation section 10, respectively. The controlling apparatus 20 functions as ink supplying amount controlling means for adjusting the ink supplying amount for each key zone of the ink key 7, and controls an opening and closing apparatus not shown for opening and closing the ink key 7 and can adjust the key opening independently for each of the ink keys 7 of the printing units 2a, 2b, 2c and 2d.

Further, a display apparatus (printing area monitor) for displaying a printing picture with respect to the paper surface is connected to the calculation apparatus 10, and the printing area monitor 40 has also a function as a touch panel. By the touch panel 40, plate making data converted into an image for the printing surface of the printing sheet 8 or the printing surface of the printing sheet 8 whose image is picked up by the line sensor type IRGB densitometer 1 is displayed and an arbitrary region on the printing surface can be selected by a finger of the user. Further, data, for example, of a printing characteristic information DB (AM100 DB) 141 ready for AM100 lines, a printing characteristic information DB (FM DB) 142 ready for FM and so forth are stored in advance in a storage region in the PC 12.

In the present embodiment, a look-up table (LUT) wherein a corresponding relationship between color mixture halftone densities and tone values is defined is used as the printing characteristic information. To and in the AM100 DB 141 and the FM DB 142, a look-up table (LUT) as the printing characteristic information determined in advance regarding AM100 line screening and FM screening is inputted from an inputting apparatus not shown of the PC 12 and stored (printing characteristic information acquisition means).

A derivation method of the LUT is described below. For example, where an LUT ready for screening of AM100 lines is to be determined, first a printing plate made by screening the printing picture [picture having various (928 kinds of) combinations of four ink colors [black (k), cyan (c), magenta (m), yellow (y)] which are basic colors] of the Japan Color for Newspaper Printing established by the ISO/TC130 National Commission with the AM100 lines by a RIP (Raster Image Processor) not shown or the like is printed with a reference density Ds and then actual measurement of the printing plate is carried out using an IRGB densitometer. Consequently, a look-up table (LUT) of actual measurement values (values of a color mixture halftone density IRGB) by the IRGB densitometer corresponding to various combinations of tone values of the four ink colors k, c, m and y can be determined.

Further, where an LUT ready for FM screening is determined, similarly to the LUT ready for screening of the AM100 lines, a printing plate made by screening the printing picture of the Japan Color for Newspaper Printing described above by an FM method is printed with the reference density Ds and actual measurement for the printing plate is carried out using an IRGB densitometer, and as a result, a look-up table ready for screening of the FM method can be determined.

It is to be noted that the LUTs ready for different kinds of screening need not be determined every time printing is carried out but may be determined when a printing characteristic changes such as when a printing material (paper, ink, blanket or the like) changes or the like.

Further, while an LUT in the present embodiment is determined only for two kinds of screening of the AM100 lines and FM, in addition to the LUTs for the AM100 lines and FM, an LUT may be determined also for different kinds of AM screening wherein the number of lines is different from that of the AM100 lines such as, for example, AM174 lines, AM250 lines or the like similarly to the AM100 lines and the determined LUT may be stored into the storage region of the PC 12. It is to be noted that the number of lines represents a quantity regarding what number of halftone dots (lines) should be disposed per one inch when AM screening is carried out, and represents the number of halftone dots per unit area.

Incidentally, in the case of a nationwide newspaper, a paper surface production part for producing contents of a paper surface is processed mainly by the base station side and a printing part is processed mainly by the printing factory side at various places.

In the information processing section 18, prior to color tone control when printing is carried out, plate making data and job ticket data (page allocation information, M/C page allocation information, in-page noticed picture coordinates, in-page screening coordinates and so forth) including tone value data of a printing picture supplied to a reception server 41 of a printing factory are acquired from the paper surface production part (tone value data acquisition means). A noticed pixel region setting section 18A of the information processing section 18 acquires coordinates (coordinate information of the noticed pixel region described above) of the plate making data with importance attached to color matching designated by the designer in the paper surface production part to set a noticed pixel region wherein color matching is required (noticed pixel region setting means), and outputs tone values ki, ci, mi and yi of each pixel of the noticed pixel region to the color conversion section 14. Further, a screening information acquisition section 18B acquires screening kind information Sr at the coordinates of the plate making data pixel (screening information acquisition means), and outputs the acquired information to the color conversion section 14. It is to be noted that the plate making data and the job ticket data may be directly inputted to the information processing section 18 by the operator without acquiring them from the reception server 41.

Here, the plate making data and the job ticket data are described.

For example, in the paper surface production part on the base station side, the person in charge of space configuration or the like such as a designer of a paper surface to be printed carries out configuration of the paper surface to be printed and the plate making data is produced based on the configured paper surface. At this time, the designer or the like designates also what screening kind is to be used for printing of each region within the printing picture. Then, information regarding the noticed pixel region including kind information (hereinafter referred to as screening information Sr) of screening is written into the job ticket data relating to the printing described above.

The job ticket data corresponds to a process document on which attributes and procedures of printing step management (Processes), plate making (Prepress), printing (Press) and post working (Postpress) are described and is produced by the person in charge who manages the entire printing process. Then, the information regarding the noticed pixel region and the screening information Sr corresponding to the noticed pixel region are added to part of the job ticket data.

As publicly known data belonging to the kind of data described above, there are JDF (Job Definition Format) data of the CIP4 (International Cooperation for Integration of Processes in Prepress, Press, and Postpress) standards and AMPAC data of the JIS standards.

If a noticed pixel region is set, then ink supplying is controlled such that the density of each ink to be used for the set pixel region upon printing becomes a target density corresponding to the screening information Sr. Accordingly, a portion of a target printing picture at which it is desired to carry out color tone control particularly with high accuracy is set as a [noticed pixel region].

It is to be noted that, while there is no limitation to the data format of the job ticket data, since the XML language is used, for example, in the JDF of the CIP4 standards, not only a controlling instruction of a machine but also more detailed information than information to be reflected on business management can be incorporated. Therefore, it is also easy to write the information regarding the noticed pixel region. Accordingly, it is also preferable to adopt a data format of job tickets having flexibility like JDF data of the CIP4 standards.

It is to be noted that the LUTs corresponding to the kinds of screening (AM100 lines, FM) may be acquired in advance by the base station side (in the paper surface production part) so that the LUT corresponding to the screening of the noticed pixel region is written into the job ticket data. If the LUT is acquired in advance on the base station side in this manner, then the LUT need not be acquired on the printing factory (printing part) side.

Further, where the screening information is not acquired as the job ticket data, also the screening information can be acquired directly from the CTP. In the CTP, in order to carry out plate making, a kind of the screening and coordinates are recognized.

A process of color tone control is described below in order with reference to FIGS. 2, 3 and 4.

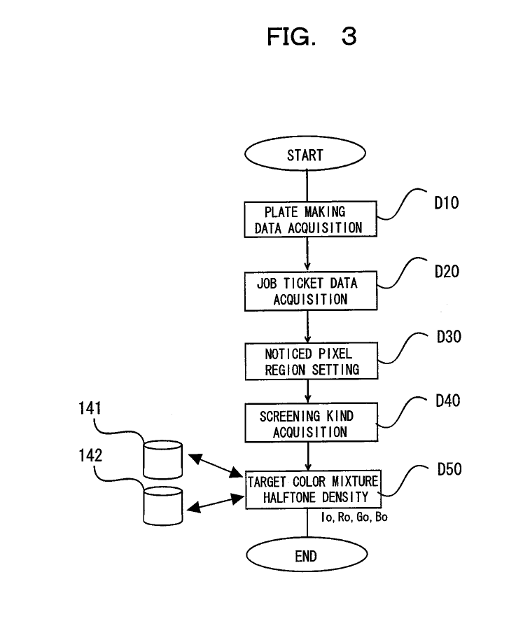

Here, as seen in FIG. 3, the information processing section 18 acquires plate making data [paper surface information of newspaper transmitted, from a base station of a newspaper company to the printing factory, in the form of bitmap data (1 bit-Tiff plate making data), JDF data corresponding to 50.8 dpi, or data (data obtained by converting 1 bit-Tiff data of 1200 dpi or 2400 dpi into 8 bit-Tiff data of 50 dpi) for which a resolution conversion process substantially equal to that of the JDF data is carried out] (step D10). Then, the information processing section 18 converts the transmitted bitmap data into low-resolution data corresponding to JDF data ready for the format of the printing press and uses the low-resolution data as pixel area coefficient data. While the conversion process of the resolution is carried out for common use with general JDF data, the bitmap data itself can be used also as the pixel area coefficient data in the later process. Further, also the job ticket data described above is acquired at the same time with the plate making data (step D20).

At step D30, the information processing section 18 automatically sets a noticed pixel region corresponding to each ink color based on coordinate information of the noticed pixel region of each ink supplying zone written in the job ticket data and outputs tone values ki, ci, mi and yi of the noticed pixels to the color conversion section 14. Further, as step D40, the screening information Sr of the noticed pixel region of each ink supplying zone is outputted from the job ticket data to the color conversion section 14. The screening corresponding to the screening information Sr is hereinafter referred to as use screening.

At step D 50, the color conversion section 14 selects an LUT corresponding to the use screening from the LUTs stored in the AM100 DB 141 and the FM DB 142 and converts the pixel tone values ki, ci, mi and yi of the automatically set noticed pixel region of each ink color into color mixture halftone densities (conversion means). Then, the color conversion section 14 averages the color mixture halftone densities over the noticed pixel region and sets the averaged color mixture halftone densities as target color mixture halftone densities Io, Ro, Go and Bo (target color mixture halftone density setting means).

It is to be noted that, since the noticed pixel region is set for each ink supplying zone, for example, where the kind of screening is different among different pages or the like, the LUT to be used is different for each ink supplying zone corresponding to each page.

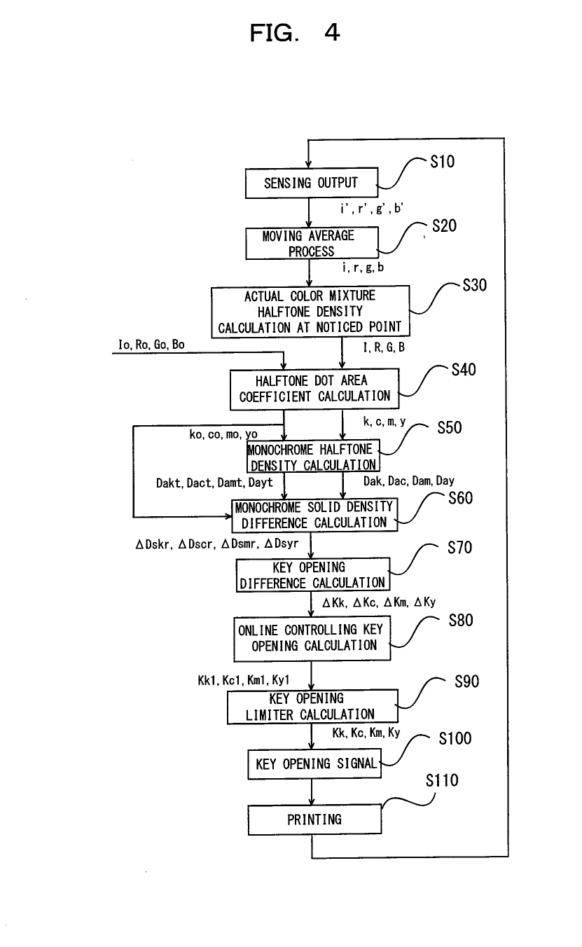

In this manner, if the target color mixture halftone densities Io, Ro, Go and Bo are set, then the processes at and after step S10 are repetitively executed as seen in FIG. 4.

First, as step S10, the line sensor type IRGB densitometer 1 measures reflection light amounts i′, r′, g′ and b′ of each pixel on the overall surface of the printing sheet 8. The reflection light amounts i′, r′, g′ and b′ of each pixel measured by the IRGB densitometer 1 are inputted to the DSP 11.

As step S20, the DSP 11 carries out moving averaging for the reflection light amounts i′, r′, g′ and b′ of each pixel in a unit of a predetermined number of prints to calculate reflection light amounts i, r, g and b of each pixel whose noise component is removed.

Then, as step S30, actual color mixture halftone densities I, R, G and B of the noticed pixel of each color are acquired using the reflection light amounts i, r, g and b of each pixel calculated at step S20 (actual color mixture halftone density acquisition means).

In particular, the DSP 11 calculates the actual color mixture halftone densities I, R, G and B from the reflection light amounts i, r, g and b at a noticed point of the printing sheet (actual printing sheet) 8 and a reflection light amount at a blank paper portion. It is to be noted that, since such noticed pixel is basically an aggregate of a plurality of pixels, an averaging process is carried out for the reflection light amounts i, r, g and b among the plural pixels which compose the noticed pixel. For example, where the reflection light amount of infrared light at a blank paper portion is defined as ip and the average reflection light amount of infrared light within a key zone is defined as ik, the actual color mixture halftone density I of infrared light is determined as I=log₁₀(ip/ik). The actual color mixture halftone densities I, R, G and B of each key zone calculated by the DSP 11 are inputted to the color conversion section 14 of the PC 12.

The color conversion section 14 carries out processes at steps S40, S50 and S60.

First, as step S40, the tone values of each ink color corresponding to the individual target color mixture halftone densities Io, Ro, Go and Bo set at step D50 and the individual actual color mixture halftone densities I, R, G and B of the noticed pixel region of each color calculated at step S30 are calculated.

An LUT ready for the use screening is used for the calculation just described, and the tone value of each ink color corresponding to the individual target color mixture halftone densities Io, Ro, Go and Bo is calculated as target tone values ko, co, mo and yo (target tone value calculation means). The tone values of each ink color corresponding to the individual actual color mixture halftone densities I, R, G and B are calculated as actual tone values k, c, m and y (actual tone value calculation means).

Next, as step S50, the color conversion section 14 calculates the monochromatic halftone density of each ink color corresponding to the individual target tone values ko, co, mo and yo and individual actual tone values k, c, m and y calculated at step S40 (target monochromatic halftone density calculation means, actual monochromatic halftone density calculation means).

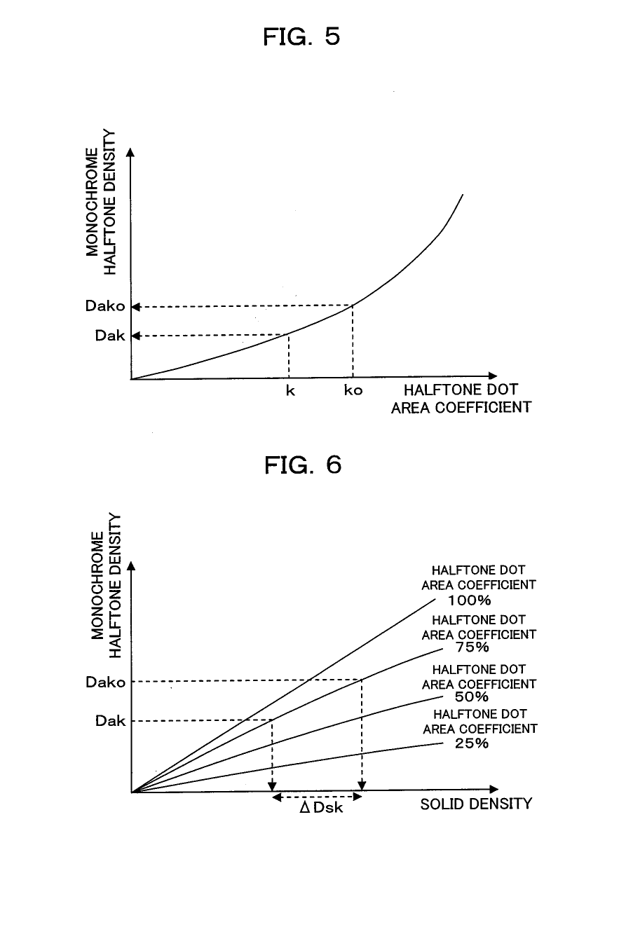

Such a map as shown in FIG. 5 is used for the calculation just described. FIG. 5 shows an example of a map on which monochromatic halftone densities actually measured where the tone value is changed are plotted as a characteristic curve and which is produced from data measured in advance. In the example shown in FIG. 5, a target tone value ko and an actual tone value k of the black color are collated with the map so that a target monochromatic halftone density Dako and an actual monochromatic halftone density Dak are determined from the characteristic curve in the map. In this manner, the color conversion section 14 determines target monochromatic halftone densities Dako, Daco, Damo and Dayo and actual monochromatic halftone densities Dak, Dac, Dam and Day of each ink color.

Then, as step S60, the color conversion section 14 calculates solid density differences ΔDsk1, ΔDsc1, ΔDsm1 and ΔDsy1 of each ink color corresponding to the differences between the noticed pixel target monochromatic halftone densities Dako, Daco, Damo and Dayo and the actual monochromatic halftone densities Dak, Dac, Dam and Day of each color (solid density difference calculation means).

It is to be noted that the solid density depends also upon the target tone value and, where the monochromatic halftone density is same, the solid density decreases as the target tone value increases. Therefore, the color conversion section 14 carries out calculation using such a map as shown in FIG. 6. FIG. 6 shows an example of a map on which monochromatic halftone densities at each tone value actually measured where the monochrome solid density is changed are plotted as a characteristic curve for each tone value and which is produced from data measured in advance. The color conversion section 14 selects such characteristic curves corresponding to the target tone values ko, co, mo and yo regarding each ink color from the map shown in FIG. 6 and associates the target monochromatic halftone densities Dako, Daco, Damo and Dayo and the actual monochromatic halftone densities Dak, Dac, Dam and Day with the selected characteristic curves. Consequently, the color conversion section 14 determines solid density differences ΔDsk1, ΔDsc1, ΔDsm1, ΔDsy1, ΔDsk2, ΔDsc2, ΔDsm2 and ΔDsy2. In the example shown in FIG. 6, where the target tone value ko of the black color is 75%, the target monochromatic halftone density Dako and the actual monochromatic halftone density Dak are collated with the map to determine the solid density difference ΔDsk of the black color from the 75% characteristic curve in the map.

The solid density differences ΔDsk, ΔDsc, ΔDsm and ΔDsy of each ink color calculated by the color conversion section 14 are inputted to the ink supplying amount calculation section 15. As step S70, the ink supplying amount calculation section 15 calculates key opening difference amounts ΔKk, ΔKc, ΔKm and ΔKy corresponding to the solid density differences ΔDsk, ΔDsc, ΔDsm and ΔDsy. The key opening difference amounts ΔKk, ΔKc, ΔKm and ΔKy represent adjustment amounts for key openings Kk0, Kc0, Km0 and Ky0 (key openings Kk, Kc, Km and Ky outputted in the preceding process at step S100 to the controlling apparatus 20 of the printing press) at present of each ink key 7, and the ink supplying amount calculation section 15 carries out calculation using the publicly known API function (auto preset inking function). It is to be noted that the API function is a function which indicates a corresponding relationship between line coefficients A (Ak, Ac, Am and Ay) of each key zone and key openings K (Kk, Kc, Km and Ky) in order to maintain the reference density, and such a line coefficient A can be determined by averaging tone values of each key zone based on the tone value data of the printing picture.

In particular, the calculation described above is carried out such that a ratio kd (kd=ΔDs/Ds) of the solid density difference ΔDs (ΔDsk, ΔDsc, ΔDsm and ΔDsy) to the reference density Ds (Dsk, Dsc, Dsm and Dsy) is determined and the key opening K for maintaining the reference density with respect to the line coefficient A is determined using the API function and then the key opening difference amount ΔK (ΔK=kd×K) for decreasing the solid density difference ΔDs to zero is determined as the product between the ratio kd and the key opening K.

Next, as step S80, the online controlling section 16 corrects the key opening difference amounts ΔKk, ΔKc, ΔKm and ΔKy taking dead time from the printing units 2a, 2b, 2c and 2d to the line sensor type IRGB densitometer 1, reaction time of the ink key 7 per unit time and a printing speed into consideration. The correction is carried out taking delay time after a key opening signal is inputted until the ink key 7 moves to change the key opening thereby to change the ink amount to be supplied to the printing sheet and the change of the ink amount is detected as a change of the reflection light amount by the IRGB densitometer 1 into consideration. As such an online feedback control system which involves long dead time as described above, for example, dead time compensation PI control, fuzzy control, robust control or the like is optimum. The online controlling section 16 inputs online controlling key openings Kk1, Kc1, Km1 and Ky1 obtained by adding the key openings Kk0, Kc0, Km0 and Ky0 at present to the corrected key opening difference amounts (online controlling key opening difference amounts) ΔKk, ΔKc, ΔKm and ΔKy to the key opening limiter calculation section 17.

As step S90, the key opening limiter calculation section 17 carries out correction for restricting an upper limit value individually for the online controlling key openings Kk1, Kc1, Km1 and Ky1 calculated by the online controlling section 16. The correction is carried out as a process for particularly restricting drastic increase of the key opening by an estimation error of the color conversion algorithm (processes at steps S40, S50 and S60) at a low line portion. Then, as step S100, the key opening limiter calculation section 17 transmits the key openings Kk, Kc, Km and Ky whose upper limit values are restricted as the key opening signal to the controlling apparatus 20 of the printing press.

As step S110, the controlling apparatus 20 of the printing press adjusts the opening of each ink key 7 of the printing units 2a, 2b, 2c and 2d based on the key opening signals Kk, Kc, Km and Ky transmitted from the calculation apparatus 10. Consequently, the ink supplying amount of each ink color is controlled as an amount corresponding to a color tone which is a target for each key zone.

Since the color tone controlling apparatus and method for a printing press according to the first embodiment of the present invention are configured in such a manner as described above, even if a plurality of kinds of screening are used jointly for the same printing plate, color tone control can be carried out for a noticed point designated by a client upon printing or a noticed point considered as an important noticed point by a designer based on a target color mixture halftone density calculated using an LUT corresponding to a kind of screening so that the color tone at the noticed point considered as an important noticed point by the client or the designer is adjusted to a desired color tone, and a high-quality print can be printed.

Further, for example, where the kind of screening to be used is different among different pages, since color tone control is carried out using a corresponding LUT, the dispersion in color tone among different pages can be reduced and color tone control can be carried out with high accuracy.

### Second Embodiment

Next, a second embodiment of the present invention is described.

It is to be noted that the present embodiment is characterized in that a dot gain characteristic is used as printing characteristic information, and, since the configuration of the other portions is similar to that in the first embodiment, description of portions similar to those in the first embodiment is omitted and similar elements to those in the first embodiment are denoted by same reference characters.

### (Functional Configuration of the Calculation Apparatus)

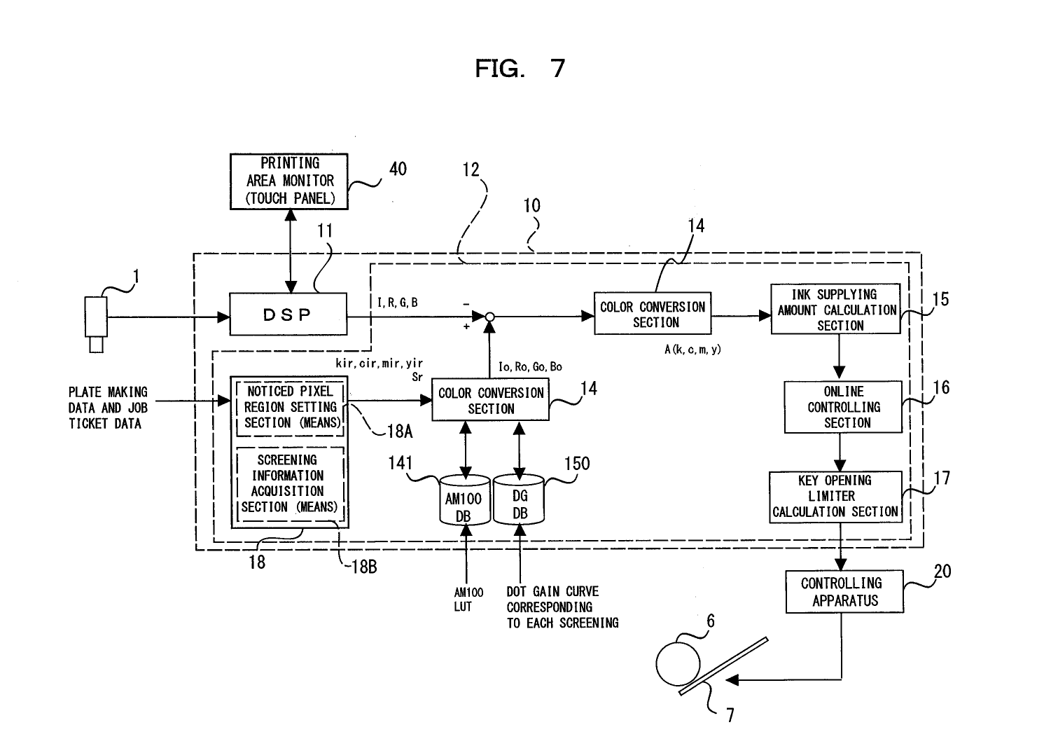

FIG. 7 is a view showing a general configuration of a picture color tone controlling apparatus for a newspaper offset rotary press as a printing press according to the second embodiment of the present invention, and is a functional block diagram showing a calculation apparatus 10 paying attention to a color tone controlling function.

It is to be noted that, as shown in FIG. 7, the present embodiment has a configuration similar to that of the first embodiment except that it includes a dot gain characteristic information DB (DG DB) 150 as the storage region of the PC 12 in place of the FM DB 142.

An LUT corresponding to AM100 lines acquired in advance by the method described above is inputted to the AM100 DB 141. It is to be noted that only one kind of an LUT (reference look-up table) is used for color tone control, and the screening (here, AM100 lines) corresponding to the LUT is referred to as reference screening. Further, the reference screening can be suitably changed not only to the AM100 lines but also to different lines. Dot gain curve information (dot gain characteristic information) corresponding to a plurality of screenings (here, AM100 lines and FM) including the reference screening acquired in advance is stored in the DG DB 150 (printing characteristic information acquisition means).

In particular, in the present embodiment, the dot gain curve information corresponding to the reference screening and the plural kinds of screening described above is used as the printing characteristic information.

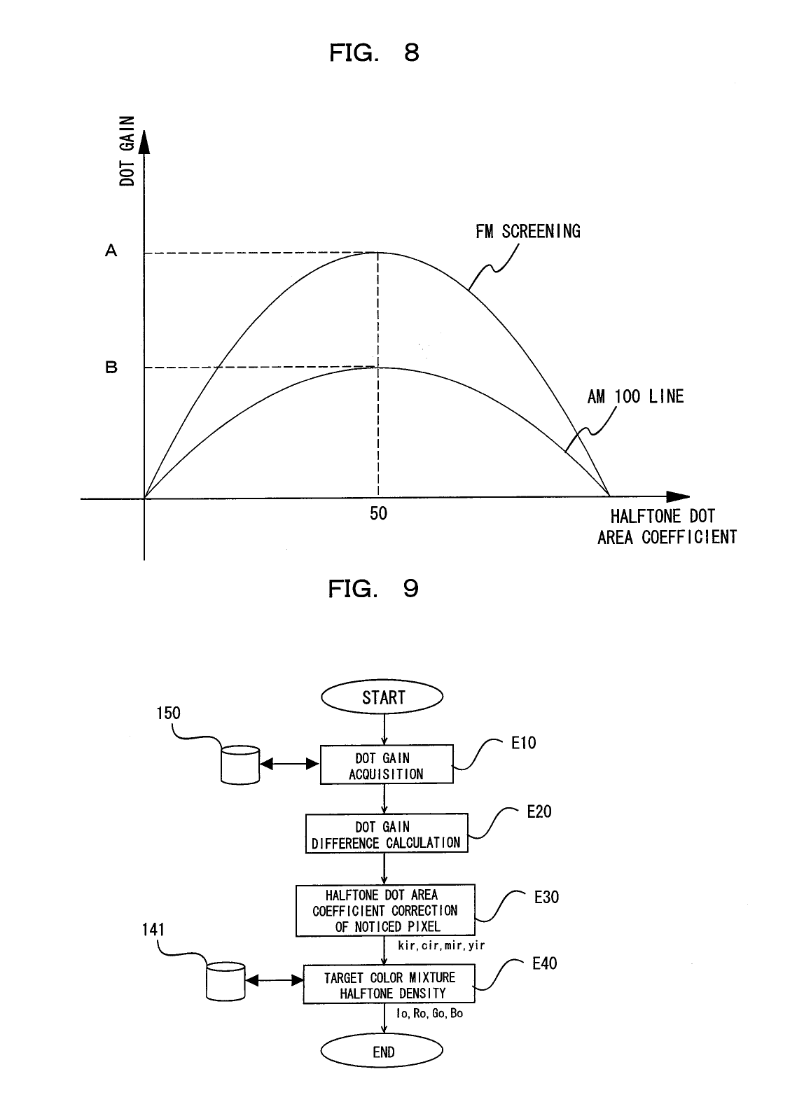

Here, a dot gain curve is described with reference to FIG. 8. A dot gain indicates a phenomenon that the size of a halftone dot of a print becomes greater than that of a halftone dot written in a printing plate because of blurring and spreading (which are called mechanical dot gain) of ink and optical spreading (called optical dot gain) of the halftone dot by multi-reflection of light entering in the halftone dot between ink and paper and reflection of the light from the ink and paper. Then, as shown in FIG. 8, the dot gain curve is represented by a graph wherein the tone value (that is, tone value of plate making data) on the printing plate is taken as the axis of abscissa and the value (dot gain amount) obtained by subtracting the tone value on the printing plate from an optical (apparent) tone value, of the halftone done actually transferred to the printing sheet, calculated in accordance with the Murray Davis's expression is taken as the axis of ordinate.

Normally, since the average peripheral length of such halftone dots becomes longer as the number of halftone dots per a unit area increases, the dot gain increases. In particular, here, the dot gain according to the FM screening is higher than that according to the AM100 lines.

As a method for acquiring the dot gain curve, the dot gain curve can be determined by actually measuring a printing sheet obtained by printing pictures of various tone values (for example, by a step of 5%) in a monochrome for each ink color in advance using a densitometer (for example, IRGB densitometer) and plotting a result of the actual measurement in accordance with the publicly known Murray Davis's expression given below.

The Murray Davis's expression is represented by

DG=(1−10^{-D})/(1−10^{-Ds})×100−arbitrary tone value on printing plate (1)

where D: density of arbitrary tone value, and Ds: 100% halftone (solid) density.

A process of color tone control in the present embodiment is described below. First, also in the present embodiment, the processes at steps D10 to D40 in FIG. 3 are carried out similarly as in the first embodiment described above.

Then, in the present embodiment, processes at steps E10 to E40 shown in FIG. 9 are carried out after the processes at steps D10 to D40 in FIG. 3.

As step E10, the color conversion section 14 acquires dot gain information corresponding to the use screening from the DG DB 150. More particularly, the color conversion section 14 acquires a dot gain amount DGi (hereinafter referred to as reference dot gain amount DGi) corresponding to the reference screening and another dot gain amount DGr (hereinafter referred to as use dot gain amount DGr) corresponding to the use screening from the DG DB 150.

Then, as step E20, the color conversion section 14 calculates the difference (DGr-DGi) between the reference dot gain amount DGi and the use dot gain amount DGr.

Then, as step E30, the difference (DGr−DGi) just described is added individually to the tone values ki, ci, mi and yi of each noticed pixel to calculate tone values kir, cir, mir and yir of each post-correction pixel (post-correction tone value calculation means).

At step E40, the color conversion section 14 converts the tone values kir, cir, mir and yir of each post-correction pixel of a controlling target pixel region into color mixture halftone densities using the LUTs stored in the AM100 DB 141 (conversion means), and sets values obtained by averaging the densities of pixels as target color mixture halftone densities Io, Ro, Go and Bo (target color mixture halftone density setting means).

If the target color mixture halftone densities Io, Ro, Go and BO are set in this manner, then the processes at and after step S10 in FIG. 4 are repetitively executed similarly as in the first embodiment.

Since the color tone controlling apparatus and method for a printing press according to the second embodiment of the present invention are configured in such a manner as described above, even if a plurality of kinds of screening are used jointly in the same printing plate, color tone control can be carried out with high accuracy by using a post-correction tone value obtained by correcting the difference between dot gain amounts of the reference screening and the use screening.

Further, the dot gain curve information can be acquired simply when the tone value of a monochrome is measured for each ink color as described above. Therefore, there is an advantage that the working amount for acquisition of the dot gain curve information is smaller than that in a case wherein a plurality of LUTs which require actual measurement of density regarding combinations of CMYK individual colors ready for the Japan color reference (928 colors) as in the first embodiment are acquired.

[Others]

While the embodiments of the present invention are described above, the present invention is not limited to the embodiments specifically described above, and variations and modifications can be made without departing from the scope of the present invention.

For example, while, in the embodiments described above, information (noticed point and kind of screening) regarding a noticed pixel region is written into job ticket data by the base station side, LUT data corresponding to the kind of screening or dot gain characteristic information may be written as the printing characteristic information in addition to the information mentioned above. In this instance, when printing is carried out, the LUT or dot gain curve data written in the job ticket may be used to carry out color tone control as in the first and second embodiments described above. In this manner, a work by a printing factory of acquiring an LUT corresponding to screening and inputting the LUT to the PC 12 or the like can be omitted.

Further, while, in the embodiments described above, the screening information Sr is written into the job ticket data, means for reading information regarding the kind of screening and arrangement from plate making data may be provided, for example, as a functional element of the PC 12.

If such means as described above is provided, then while the job ticket data is not essentially required originally for a printing work, information regarding a kind of used screening and a region can be acquired from the plate making data even if the job ticket data is not used. Further, also where the noticed pixel region is changed by the printing factory side, the kind of screening corresponding to the changed noticed region can be acquired and color tone control for a printing press can be carried out with higher flexibility.

### INDUSTRIAL APPLICABILITY OF THE INVENTION

While the present invention is suitable for use with newspaper printing and so forth wherein there is the possibility that plate making may be carried out using screening different among different pages, the present invention can be applied not only to newspaper printing and so forth but also widely to various printing presses for carrying out printing while using different kinds of screening jointly.

1. A picture color tone controlling apparatus for a printing press, comprising:
a printing characteristic information acquisition section for acquiring printing characteristic information of a printing press corresponding to different kinds of screening used for plate making of a printing picture;
a screening information acquisition section for acquiring the kinds of screening to be used for different regions of the printing picture in an associated relationship with the regions; and
an ink supplying amount controlling section for controlling a supplying amount of ink based on the printing characteristic information corresponding to the kinds of screening.

2. The picture color tone controlling apparatus for a printing press as set forth in claim 1, further comprising a noticed pixel region setting section for setting a specific pixel region in the printing picture as a noticed pixel region;
said ink supplying amount controlling section controlling the ink supplying amount based on the printing characteristic information corresponding to the kind of screening of each noticed pixel region set by said noticed pixel region setting section.

3. The picture color tone controlling apparatus for a printing press as set forth in claim 2, wherein the printing characteristic information is a look-up table for each of the kinds of screening which defines a corresponding relationship between tone values of each ink color and densities obtained by printing a predetermined picture with a reference solid density for each of the kinds of screening and actually measuring a density of the printed matter using a densitometer, and
said ink supplying amount controlling section controls the ink supplying amount using the look-up table corresponding to the kind of screening of the noticed pixel region.

4. The picture color tone controlling apparatus for a printing press as set forth in claim 3, wherein said ink supplying amount controlling section includes:
an ink supplying section for supplying ink for each of regions divided in a printing widthwise direction;
a target density setting section for setting a target density for each ink supplying width when the printing picture is divided by the ink supplying width of said ink supplying section;
an actual density acquisition section for acquiring a density of an actually printed sheet obtained by printing using the densitometer disposed on a traveling line of the actually printed sheet;
a target tone value calculation section for calculating a target tone value of each ink color corresponding to the target density based on the look-up table corresponding to the kind of screening of the noticed pixel region;
an actual tone value calculation section for calculating an actual tone value of each ink color corresponding to the actual color mixture halftone density based on the look-up table corresponding to the kind of screening of the noticed pixel region;
a target density calculation section for calculating a target density corresponding to the target tone value based on a corresponding relationship set in advance between tone values and monochromatic halftone densities;
an actual density calculation section for calculating an actual density corresponding to the actual tone value based on the corresponding relationship between the tone values and the monochromatic densities; and
a solid density difference calculation section for calculating a solid density difference corresponding to a difference between the target density and the actual density under the target tone value based on a corresponding relationship set in advance among the tone values, monochromatic halftone densities and solid densities;
said ink supplying amount controlling section controlling the ink supplying amount for each ink supplying width by feedback control based on the solid density difference.

5. The picture color tone controlling apparatus for a printing press as set forth in claim 4, wherein the target density setting section includes a tone value data acquisition section for acquiring tone value data of the printing picture and a conversion section for converting the tone value of the noticed pixel region obtained from the tone value data into a density using the look-up table corresponding to the kind of screening of the noticed pixel region, and is configured so as to set the density of the noticed pixel region as the target color mixture halftone density,
the actual density acquisition section being configured so as to acquire the actual density of the noticed pixel.

6. The picture color tone controlling apparatus for a printing press as set forth in claim 2, wherein the printing characteristic information includes a reference look-up table which defines a corresponding relationship between tone values of each ink color and densities obtained by printing a predetermined picture of a printing plate made in accordance with the screening which is a reference with a reference solid density and measuring a density of the printed matter using a densitometer and
dot gain characteristic information corresponding to the kind of screening,
said ink supplying amount controlling section controlling the ink supplying amount based on the reference look-up table and a difference between the dot gain characteristic information corresponding to the kind of screening of the noticed pixel region and the dot gain characteristic information corresponding to the kind of screening which is a reference.

7. The picture color tone controlling apparatus for a printing press as set forth in claim 6, wherein said ink supplying amount controlling section includes:
an ink supplying section for supplying ink for each of regions divided in a printing widthwise direction;
a target density setting section for setting a target density for each ink supplying width when the printing picture is divided by the ink supplying width of said ink supplying section;
an actual density acquisition section for acquiring a density of an actually printed sheet obtained by printing using a densitometer disposed on a traveling line of the actually printed sheet;
a target tone value calculation section for calculating a target tone value of each ink color corresponding to the target color mixture halftone density based on the reference look-up table;
an actual tone value calculation section for calculating an actual tone value of each ink color corresponding to the actual density based on the reference look-up table;
a target density calculation section for calculating a target density corresponding to the target tone value based on a corresponding relationship set in advance between tone values and monochromatic densities;
an actual density calculation section for calculating an actual density corresponding to the actual tone value based on the corresponding relationship between the tone values and the monochromatic densities; and
a solid density difference calculation section for calculating a solid density difference corresponding to a difference between the target density and the actual density under the target tone value based on a corresponding relationship set in advance among the tone values, monochromatic densities and solid densities;
said ink supplying amount controlling section controlling the ink supplying amount for each ink supplying width by feedback control based on the solid density difference.

8. The picture color tone controlling apparatus for a printing press as set forth in claim 7, wherein said target density setting section includes a tone value data acquisition section for acquiring tone value data of the printing picture, a post-correction tone value calculation section for calculating a post-correction tone value to be obtained by correcting the tone value of the noticed pixel region obtained from the tone value data based on a difference between the dot gain characteristic information corresponding to the kind of screening of the noticed pixel region and the dot gain characteristic information corresponding to the kind of screening which is a reference and a conversion section for converting the post-correction tone value into the density using the reference look-up table, and is configured so as to set the converted density of the noticed pixel region as the target density,
the actual density acquisition section being configured so as to acquire the actual density of the noticed pixel.

9. The picture color tone controlling apparatus for a printing press as set forth in claim 1, wherein said screening information acquisition section acquires the screening information from job ticket data.

10. The picture color tone controlling apparatus for a printing press as set forth in claim 1, wherein said screening information acquisition section acquires the screening information from plate making data.

11. The picture color tone controlling apparatus for a printing press as set forth in claim 1, wherein said printing characteristic information acquisition section acquires the printing characteristic information from job ticket data.

12. A picture color tone controlling method for a printing press, comprising:
a printing characteristic information acquisition step of acquiring printing characteristic information of a printing press corresponding to different kinds of screening used for plate making of a printing picture;
a screening information acquisition step of acquiring the kinds of screening to be used for different regions of the printing picture in an associated relationship with the regions; and
an ink supplying amount controlling step of controlling a supplying amount of ink based on the printing characteristic information corresponding to the kinds of screening.

13. The picture color tone controlling method for a printing press as set forth in claim 12, further comprising a noticed pixel region setting step of setting a specific pixel region in the printing picture as a noticed pixel region; and wherein,
at the ink supplying amount controlling step, the ink supplying amount is controlled based on the printing characteristic information corresponding to the kind of screening of each noticed pixel region.

14. The picture color tone controlling method for a printing press as set forth in claim 13, wherein the printing characteristic information is a look-up table for each of the kinds of screening which defines a corresponding relationship between tone values of each ink color and densities obtained by printing a predetermined picture with a reference solid density for each of the kinds of screening and actually measuring a density of the printed matter using a densitometer, and,
at the ink supplying amount controlling step, the ink supplying amount is controlled using the look-up table corresponding to the kind of screening of the noticed pixel region.

15. The picture color tone controlling method for a printing press as set forth in claim 14, wherein the ink supplying amount controlling step includes:
a target density setting step of setting a target density for each ink supplying width when the printing picture is divided by the ink supplying width of the ink supplying section;
an actual density acquisition step of acquiring a density of an actually printed sheet obtained by printing using the densitometer disposed on a traveling line of the actually printed sheet;
a target tone value calculation step of calculating a target tone value for each ink color corresponding to the target density based on the look-up table corresponding to the kind of screening of the noticed pixel region;
an actual tone value calculation step of calculating an actual tone value for each ink color corresponding to the actual density based on the look-up table corresponding to the kind of screening of the noticed pixel region;
a target density calculation step of calculating a target density corresponding to the target tone value based on a corresponding relationship set in advance between tone values and monochromatic halftone densities;
an actual density calculation step of calculating an actual density corresponding to the actual tone value based on the corresponding relationship between the tone value and the monochromatic halftone density; and
a solid density difference calculation step of calculating a solid density difference corresponding to a difference between the target density and the actual density under the target tone value based on a corresponding relationship set in advance among the tone values, monochromatic densities and solid densities;
the ink supplying amount being controlled for each ink supplying width by feedback control based on the solid density difference.

16. The picture color tone controlling method for a printing press as set forth in claim 15, wherein the target density setting step includes a tone value data acquisition step of acquiring tone value data of the printing picture and a conversion step of converting the tone value of the noticed pixel region obtained from the tone value data into a density using the look-up table corresponding to the kind of screening of the noticed pixel region, and is configured so as to set the density of the noticed pixel region as the target density,
the actual density acquisition step being configured so as to acquire the actual density of the noticed pixel.

17. The picture color tone controlling method for a printing press as set forth in claim 13, wherein the printing characteristic information includes a reference look-up table which defines a corresponding relationship between tone values of each ink color and densities obtained by printing a predetermined picture of a printing plate made in accordance with the screening which is a reference with a reference solid density and measuring a density of the printed matter using a densitometer and
dot gain characteristic information corresponding to the kind of screening,
the ink supplying amount being controlled at the ink supplying amount controlling step based on the reference look-up table and a difference between the dot gain characteristic information corresponding to the kind of screening of the noticed pixel region and the dot gain characteristic information corresponding to the kind of screening which is a reference.

18. The picture color tone controlling method for a printing press as set forth in claim 17, wherein the ink supplying amount controlling step includes:
a target density setting step of setting a target density for each ink supplying width when the printing picture is divided by the ink supplying width of the ink supplying section;
an actual color mixture halftone density acquisition step of acquiring a density of an actually printed sheet obtained by printing using the densitometer disposed on a traveling line of the actually printed sheet;
a target tone value calculation step of calculating a target tone value of each ink color corresponding to the target density based on the reference look-up table;
an actual tone value calculation step of calculating an actual tone value of each ink color corresponding to the actual density based on the reference look-up table;
a target density calculation step of calculating a target density corresponding to the target tone value based on a corresponding relationship set in advance between tone values and monochromatic densities;
an actual density calculation step of calculating an actual density corresponding to the actual tone value based on the corresponding relationship between the tone values and the monochromatic densities; and
a solid density difference calculation step of calculating a solid density difference corresponding to a difference between the target density and the actual density under the target tone value based on a corresponding relationship set in advance among the tone values, monochromatic densities and solid densities;
the ink supplying amount being controlled for each ink supplying width by feedback control based on the solid density difference.

19. The picture color tone controlling method for a printing press as set forth in claim 18, wherein the target density setting step includes a tone value data acquisition step of acquiring tone value data of the printing picture, a post-correction tone value calculation step of calculating a post-correction tone value to be obtained by correcting the tone value of the noticed pixel region obtained from the tone value data based on a difference between the dot gain characteristic information corresponding to the kind of screening of the noticed pixel region and the dot gain characteristic information corresponding to the kind of screening which is a reference and a conversion step of converting the post-correction tone value into the density using the reference look-up table, and is configured so as to set the converted density of the noticed pixel region as the target density,
the actual density acquisition step being configured so as to acquire the actual density of the noticed pixel.

20. The picture color tone controlling method for a printing press as set forth in claim 12, wherein, at the screening information acquisition step, the screening information is acquired from job ticket data.

21. The picture color tone controlling method for a printing press as set forth in claim 12, wherein, at the screening information acquisition step, the screening information is acquired from plate making data.

22. The picture color tone controlling method for a printing press as set forth in claim 12, wherein, at the printing characteristic information acquisition step, the printing characteristic information is acquired from job ticket data.

23. The picture color tone controlling apparatus for a printing press as set forth in claim 2, wherein the printing characteristic information is a look-up table for each of the kinds of screening which defines a corresponding relationship between tone values of each ink color and colors obtained by printing a predetermined picture with a reference color for each of the kinds of screening and actually measuring a color of the printed matter using a measuring instrument, and
said ink supplying amount controlling section controls the ink supplying amount using the look-up table corresponding to the kind of screening of the noticed pixel region.

24. The picture color tone controlling apparatus for a printing press as set forth in claim 2, wherein the printing characteristic information includes a reference look-up table which defines a corresponding relationship between tone values of each ink color and colors obtained by printing a predetermined picture of a printing plate made in accordance with the screening which is a reference with a reference color and measuring a color of the printed matter using a measuring instrument and
dot gain characteristic information corresponding to the kind of screening,
said ink supplying amount controlling section controlling the ink supplying amount based on the reference look-up table and a difference between the dot gain characteristic information corresponding to the kind of screening of the noticed pixel region and the dot gain characteristic information corresponding to the kind of screening which is a reference.

25. The picture color tone controlling method for a printing press as set forth in claim 13, wherein the printing characteristic information is a look-up table for each of the kinds of screening which defines a corresponding relationship between tone values of each ink color and colors obtained by printing a predetermined picture with a reference color for each of the kinds of screening and actually measuring a color of the printed matter using a measuring instrument, and,
at the ink supplying amount controlling step, the ink supplying amount is controlled using the look-up table corresponding to the kind of screening of the noticed pixel region.

26. The picture color tone controlling method for a printing press as set forth in claim 13, wherein the printing characteristic information includes a reference look-up table which defines a corresponding relationship between tone values of each ink color and colors obtained by printing a predetermined picture of a printing plate made in accordance with the screening which is a reference with a reference color and measuring a color of the printed matter using a measuring instrument and
dot gain characteristic information corresponding to the kind of screening,
the ink supplying amount being controlled at the ink supplying amount controlling step based on the reference look-up table and a difference between the dot gain characteristic information corresponding to the kind of screening of the noticed pixel region and the dot gain characteristic information corresponding to the kind of screening which is a reference.
